(19) United States
(12) Patent Application Publication
(10) Pub. No.: US 2012/0036421 A1
(43) Pub. Date: Feb. 9, 2012

(54) ELECTRONIC TEMPLATE CONVERTING METHOD, APPARATUS, AND RECORDING MEDIUM

(75) Inventors: Kyeongrim Ahn, Seoul (KR); Sangpil Park, Uiwang-si (KR); Soomin Park, Seoul (KR); Sunho Park, Seoul (KR)

(73) Assignee: KL-NET CORPORATION, Seoul (KR)

(21) Appl. No.: 13/265,799

(22) PCT Filed: Apr. 20, 2010
(86) PCT No.: PCT/KR10/02436

§ 371 Date: Oct. 21, 2011

(30) Foreign Application Priority Data
Apr. 23, 2009 (KR) 10-2009-0035595

(51) Int. Cl. G06F 17/00

(52) U.S. Cl. 715/223

(57) ABSTRACT

The present disclosure relate to an electronic form converting method, apparatus, and recording medium. The apparatus includes unit for receiving an electronic form conversion request along with requested form; analyzer for analyzing requested form to generate analysis information based on analysis result and determining whether requested form is valid based on analysis information and predefined criteria information; generator for generating standard form by converting requested form with predefined criteria information if requested form is determined as valid; generator for generating converted form by converting standard form in response to and based on information on conversion format inputted; and converted form provider for providing converted form responding to electronic form conversion request. The present disclosure converts extensive types/formats of electronic document into standard form leading to fluent exchanges of electronic documents and enhanced job performance and further provides standards forms converted to custom formats by user requirements improving user convenience.

### TECHNICAL FIELD

The present disclosure relates to a method, apparatus, and recording medium for converting an electronic document form. More particularly, the present disclosure relates to a method for converting electronic document forms from a wide variety of formats to a standardized form, to an apparatus, and to a recording medium therefor.

### BACKGROUND ART

The statements in this section merely provide background information related to the present disclosure and may not constitute the prior art.

In recent years, e-business and IT and related technologies have rapidly evolved to the point where e-commerce transactions between businesses outdated exchanging paper documents with electronically processing information as a basis for executing the intercorporate transactions.

In other words, there have been efforts to attain business cost saving, reduced transaction time, increased efficiency of business management, enhanced competitiveness and the like through using electronic documents.

However, despite the advantages of using the electronic documents, people still largely use the traditional paper form in parallel with the electronic counterpart.

Meanwhile, conventional electronic documents have existed in fairly diverse types or formats, which can be major obstacles to fluent exchanges of the electronic documents and the business activities involving these electronic documents, and raised the issue of compatibility between systems, which generated unnecessary cost for interoperability such as system adjustments and additions.

### DISCLOSURE

### Technical Problem

Therefore, the present disclosure has been made in view of the above mentioned problems to provide converting extensive types or formats of electronic documents into a standard form to offer.

Further, the present disclosure has been also made to provide converting the extensive types or formats of electronic documents into the standard form to achieve fluent exchanges of electronic documents and thus enhanced job performance.

Further, the present disclosure has been also made to provide converting the extensive types or formats of electronic documents into the standard form to effectuate enhancements of the interoperability and efficiency in business-to-business.

Further, the present disclosure has been also made for converting the extensive types or formats of electronic documents into the standard form and subsequently converting the standard form to a custom form by user requirements to increase the user convenience.

### Technical Solution

An aspect of the present disclosure provides an apparatus for converting an electronic document form including: a form conversion request unit for receiving an electronic form conversion request along with a form under request; a form analyzer for doing analysis of the form under request to generate an analysis information based on a result of the analysis and determining whether the form under request is valid based on the analysis information and a predefined criteria information; a standard form generator for generating a standard form by converting the form under request by using the predefined criteria information if the form under request is determined as valid; a converted form generator for generating a converted form by converting the standard form in response to and based on an information on a conversion format inputted; and a converted form provider for providing the converted form in response to the electronic form conversion request.

Another aspect of the present disclosure provides a method for converting an electronic document form including: receiving an electronic form conversion request along with a form under request; doing analysis of the form under request to generate an analysis information based on a result of the analysis and determining whether the form under request is valid based on the analysis information and a predefined criteria information; generating a standard form by converting the form under request by using the predefined criteria information if the form under request is determined as valid; generating a converted form by converting the standard form in response to and based on an information on a conversion format inputted; and providing the converted form in response to the electronic form conversion request.

Yet another aspect of the present disclosure provides a computer readable recording medium storing a program for implementing a method for converting an electronic form, the program implementing functions of: doing analysis of a form under request to generate an analysis information based on a result of the analysis and determining whether the form under request is valid based on the analysis information and a predefined criteria information; generating a standard form by converting the form under request by using the predefined criteria information if the form under request is determined as valid; and generating a converted form by converting the standard form in response to and based on an information on a conversion format inputted.

### Advantageous Effects

According to the present disclosure as described above, extensive types or formats of electronic documents may become converted into a standard form to be provided.

In addition, according to the present disclosure, converting the extensive types or formats of electronic documents into the standard form will lead to fluent exchanges of electronic document forms and enhanced job performance.

In addition, according to the present disclosure, converting the extensive types or formats of electronic documents into the standard form will also effectuate enhancements of the interoperability and efficiency in business-to-business.

Further, according to the present disclosure, converting the extensive types or formats of electronic documents into the standard form and subsequently converting the standard form to a custom format by user requirements will increase user convenience in practice.

### DESCRIPTION OF DRAWINGS

FIG. 1 is a block diagram illustrating an apparatus for converting an electronic document form according to an aspect, and

FIG. 2 a flow diagram illustrating a method for converting an electronic document form according to an aspect.

### MODE FOR INVENTION

Hereinafter, aspects of the present disclosure will be described in detail with reference to the accompanying drawings. In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

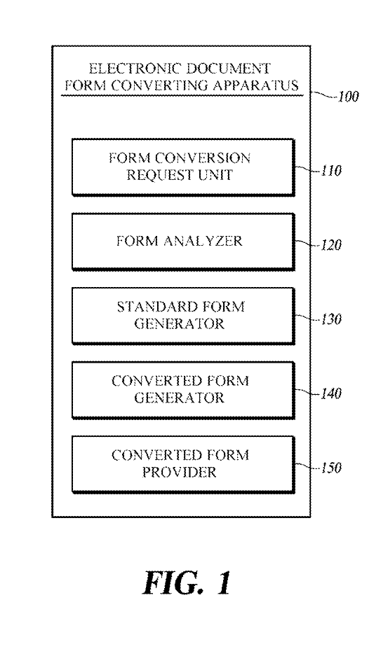

FIG. 1 is a block diagram illustrating an electronic document form converting apparatus 100 according to an aspect.

Referring to FIG. 1, electronic document form converting apparatus 100 according to an aspect includes a form conversion request unit 110 for receiving an electronic form conversion request along with a document or form under request; a form analyzer 120 for doing analysis of the form under request to generate an analysis information based on a result of the analysis and determining whether the form under request is valid based on the analysis information and a predefined criteria information; a standard form generator 130 for generating a standard form by converting the form under request by the predefined criteria information if the form under request is determined as valid; a converted form generator 140 for generating a converted form by converting the standard form in response to and based on an information on a conversion format inputted; and a converted form provider 150 for providing the converted form in response to the electronic form conversion request.

The aforementioned form under request received by form conversion request unit 110 may be different types of electronic document forms, and examples of the form under request may be one or more of an electronic data interchange (EDI) electronic document, a user defined format (UDF) electronic document, and an electronic business extensible markup language (ebXML) electronic document.

The form analyzer 120 analyzes the form under request which is simultaneously received with the electronic form conversion request and may be in a variety of types to generate the analysis information including one or more of a type, syntax, structure, rules, and size of the form under request based on the result of the analysis.

Then, form analyzer 120, based on the analysis information, performs a validity identification (also called validity test or validity check) which is a process for checking if the form under request satisfies particular conditions. Here, the particular conditions may be predefined criteria information to establish the standard form.

In other words, form analyzer 120 preliminarily defines and stores criteria information including one or more of a type, syntax, structure, rules, and size of the standard form, and performs a comparison of the analysis information previously generated from analyzing the form under request against the predefined criteria information in store to confirm whether the form under request is valid to get the electronic form converting, based on the result of comparison.

Form analyzer 120 prosecutes the validity identification process to see if the form under request is confirmed valid, and if yes, standard form generator 130 converts the form under request to the standard form by the predefined criteria information. In this case, the standard form generator 130 may generate an extensible markup language (XML) document for example as the standard form.

If form analyzer 120, after the validity identification process, finds the form under request is determined as invalid, it may provide the user with an alarm indicating “no validity identifiable” if the form under request is not determined as valid.

If standard form generator 130 generates the standard form by converting the form under request, the converted form generator 140 converts the standard form from standard form generator 130 into a conversion format type and generates the converted document finalized to offer to the user out of the standard document converted into the conversion format type upon receiving a conversion format conversion request received from a user terminal.

The aforementioned conversion format type may include one or more of a hyper text markup language (HTML) type, a portable document format (PDF) type, a word type, and an image type.

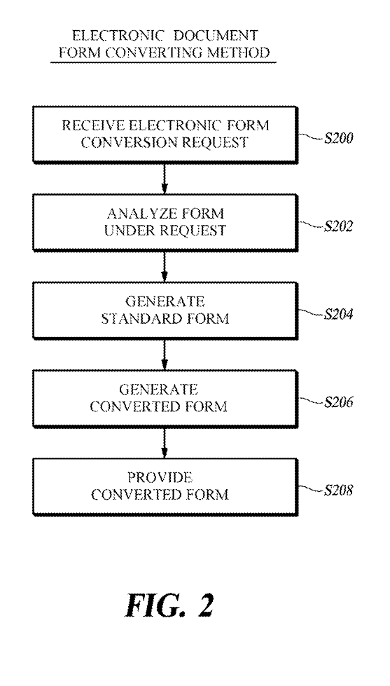

The above-mentioned electronic document format converting apparatus 100 provides a method of converting electronic document form which is illustrated in a flow diagram of FIG. 2.

FIG. 2 a flow diagram illustrating the electronic document form converting method according to an aspect.

Referring to FIG. 2, an electronic document form converting method according to another aspect includes steps of receiving an electronic form conversion request along with a form under request (S200); doing analysis of the form under request to generate an analysis information based on a result of the analysis and determining whether the form under request is valid based on the analysis information and a predefined criteria information (S202); generating a standard form by converting the form under request by using the predefined criteria information if the form under request is confirmed valid (S204); generating a converted form by converting the standard form in response to and based on information on a conversion format inputted (S206); and providing the converted form in response to the electronic form conversion request (S208).

The electronic document form converting method of electronic document form converting apparatus 100 according to an aspect may be implemented on a computer program and provided in a computer readable recording medium.

The program stored on the computer readable recording medium for implementing the method for converting an electronic document form according to an aspect implements functions of: doing analysis of a form under request to generate analysis information based on a result of the analysis and determining whether the form under request is valid based on the analysis information and a predefined criteria information; generating a standard form by converting the form under request by using the predefined criteria information if the form under request is determined to as valid; and generating a converted form by converting the standard form in response to and based on an information on a conversion format inputted.

The computer readable recording medium which has the program recorded to implement the electronic document form converting method may comprise any kinds of recording devices for recording data readable by computer systems.

Examples of such computer readable recording medium include ROM, RAM, CD-ROM, magnetic tapes, floppy discs, and optical data storages, and further comprise an implementation in carrier waves (for example, transmission over the Internet). In addition, the computer readable recording medium may be provided in a distributed processing system where computer systems are networked to store and execute the computer readable codes at distributed locations.

In addition, the functional program, code, and code segments for implementing the present disclosure may be easily deduced by programmers in the art.

As described above, the present disclosure provides an advantageous effect of having extensive types or formats of electronic documents converted into a standard form to offer.

Further, the present disclosure provides converting the extensive types or formats of electronic documents into the standard form to achieve fluent exchanges of electronic forms and enhanced job performance.

Further, the present disclosure provides converting the extensive types or formats of electronic documents into the standard form to effectuate enhancements of the interoperability and efficiency in business-to-business. In other words, savings may be provided obviating the presently unnecessary cost for interoperability such as system adjustments and additions due to otherwise varied formats or types of the electronic documents.

Furthermore, the present disclosure provides converting the extensive types or formats of electronic documents into the standard form and a subsequent conversion of the standard form to a custom format by user requirements to increase the user convenience.

Furthermore, the present disclosure empowers the full-scale changeover to digital papers or electronic forms to realize the paperless electronic transactions taking advantage of the data reusability and the shortened processing time which turn into time and cost savings up to the scale of national economics.

In the description above, although all of the components of the embodiments of the present disclosure may have been explained as assembled or operatively connected as a unit, the present disclosure is not intended to limit itself to such embodiments. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary embodiments of the present disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes. Accordingly, the scope of the disclosure is not to be limited by the above embodiments but by the claims and the equivalents thereof.

### CROSS-REFERENCE TO RELATED APPLICATION

If applicable, this application claims priority under 35 U.S.C. §119(a) of Patent Application No. 10-2009-0035595, filed on Apr. 23, 2009, the entire content of which is incorporated herein by reference. In addition, this non-provisional application claims priority in countries, other than the U.S., with the same reason based on the Korean Patent Application, the entire content of which is hereby incorporated by reference.

1. An apparatus for converting an electronic document form comprising:
a form conversion request unit for receiving an electronic form conversion request along with a form under request;
a form analyzer for doing analysis of the form under request to generate an analysis information based on a result of the analysis and determining whether the form under request is valid based on the analysis information and a predefined criteria information;
a standard form generator for generating a standard form by converting the form under request by using the predefined criteria information if the form under request is determined as valid;
a converted form generator for generating a converted form by converting the standard form in response to and based on an information on a conversion format inputted; and
a converted form provider for providing the converted form in response to the electronic form conversion request.

2. The apparatus of claim 1, wherein the form analyzer does analysis of the form under request to generate the analysis information including one or more of a type, syntax, structure, rules, and size of the form under request based on the result of the analysis.

3. The apparatus of claim 1, wherein the form analyzer defines and stores the predefined criteria information including one or more of a type, syntax, structure, rules, and size of the standard form, and performs a comparison of the analysis information to the predefined criteria information to confirm whether the form under request is valid based on the result of the comparison.

4. The apparatus of claim 1, wherein the form analyzer provides an alarm indicating “no validity identifiable” if the form under request is not determined as valid.

5. The apparatus of claim 1, wherein the form under request includes one or more of an electronic data interchange (EDI) electronic document, a user defined format (UDF) electronic document, and an electronic business extensible markup language (ebXML) electronic document.

6. The apparatus of claim 1, wherein the standard form generator generates an extensible markup language (XML) document as the standard form.

7. The apparatus of claim 1, wherein the converted form generator converts the standard form into a conversion format type and generates the converted form from the standard form converted to the conversion format type upon receiving a conversion format conversion request from a user terminal.

8. The apparatus of claim 8, wherein the conversion format type includes one or more of a hyper text markup language (HTML) type, a portable document format (PDF) type, a word type, and an image type.

9. A method for converting an electronic document form comprising:
receiving an electronic form conversion request along with a form under request;
doing analysis of the form under request to generate an analysis information based on a result of the analysis and determining whether the form under request is valid based on the analysis information and a predefined criteria information;
generating a standard form by converting the form under request by using the predefined criteria information if the form under request is determined as valid;
generating a converted form by converting the standard form in response to and based on an information on a conversion format inputted; and
providing the converted form in response to the electronic form conversion request.

10. A computer readable recording medium storing a program for implementing a method for converting an electronic document form, the program implementing functions of:
doing analysis of a form under request to generate an analysis information based on a result of the analysis and determining whether the form under request is valid based on the analysis information and a predefined criteria information;
generating a standard form by converting the form under request by using the predefined criteria information if the form under request is determined as valid; and
generating a converted form by converting the standard form in response to and based on an information on a conversion format inputted.
